(19) United States
(12) Patent Application Publication
(10) Pub. No.: US 2021/0372045 A1
(43) Pub. Date: Dec. 2, 2021

(54) CONSTRUCTIVE ARRANGEMENTS IN 6-STRAND SYNTHETIC TWISTED LARIAT ROPE

(71) Applicant: DANIEL FACHIN, Toledo (BR)

(72) Inventor: DANIEL FACHIN, Toledo (BR)

(21) Appl. No.: 16/830,452

(22) Filed: Mar. 26, 2020

(51) Int. Cl. D07B 1/02; D07B 1/04; A01K 15/00

(52) U.S. Cl. CPC D07B 1/025; D07B 1/04; A01K 15/003; D07B 2201/1014; D07B 2205/2046; D07B 2201/104; D07B 2201/2009; D07B 2205/2039; D07B 2201/102

(57) ABSTRACT

It refers to the invention of a 6-strand synthetic twisted lariat rope, a product used in Team Roping competitions. It is also used in cattle handling, when it is necessary to immobilize an animal, preserving its sanity and physical integrity, avoiding injuries, friction burns due to impact and/or traction. It is a dynamic, elastic, anti-static rope where the harmful effect of the impact of a sudden stop is practically nil, which follows all the requirements of the Federal Law 10.591/02. First and foremost, the animal welfare is taken into account in Team Roping competitions. The evolution of Team Roping competitions is under constant improvement in Brazil and in the world, to which the present invention brings several benefits.

### INVENTION FIELD

This invention relates to a new design of 6-strand twisted lariat rope, made of synthetic material, containing 6 strands twisted together around a core. It makes essential equipment for Team Roping practice or management and containment of animals in rural properties and livestock sectors.

Actually, the present invention relates to a new conception of 6-strand twisted lariat rope, made of polyester and polyamide. It is mainly designed for lasso competitions, besides having other applications in the rural sector, livestock or in sport competitions, such as rodeos.

### INVENTION BACKGROUND

It is widely known that ropes exist since Stone Age, primitive men made them with twisted fibers or animal leather and reinforced them with a resinous material. However, with human evolution, new materials and improvements have been developed in relation to this technique, and to this day, new models have been developed for different uses and manufactured in many different ways. There are rescue ropes, which are manufactured with twisted fibers, woven or arranged in a cover and core shape. Lifeline ropes have a cover and a core. The core is made up of thousands of fibers and accounts for about 80% of the resistance of the rope. The cover coats the core, protecting it against abrasion and other aggressive agents, accounting for the remaining 20% of the resistance of the rope. There are climbing ropes, which are made with braided nylon strands. In the present invention, we deal exclusively with lariat ropes for Team Roping competitions, which are produced with the joint of strands, and can be produced with Nylon, polyester, polyamide (PA), polypropylene (PP), elastanes and aramids. The joints between the strands are usually simple and not twisted.

One of the uses of the developed rope, to which the present patent is applied, is for Team Roping. This competition consists of a functional ride of the equestrian environment in which a pair of horseback riders attempt to immobilize a steer roping the animal's head, and turning the steer left, at which point the rider coming behind him ropes the hind legs of the steer, immobilizing it in the fastest possible time. The ride takes place in an arena prepared with sand soil where there is a stripping chute to contain this animal, and the riders are positioned, each on one side of the steer. The rider on the left side of the chute is called the header, because it is his responsibility to rope the head of the steer by the horns or by the neck. In official competitions, steers use a shield on their heads around the horns to avoid any friction or hanging injury. The competitor on the right side is called the heeler, and it is his role to rope hind legs of the steer, immobilizing it. It is worth mentioning that this is a common daily practice in handling of farms for breeding beef cattle. The steer needs to be immobilized for its own safety when applying vaccines, preventing diseases or healing injuries and infectious processes, which can compromise their sanity and physical integrity throughout the life of the animal.

Competition ropes always have as their peculiar objective of invention or improvement the animal welfare as well as the well-being of the competitor. Not using a rope that fits the norms of the Law No 10.519, of 17 Jul. 2002 can result in several penalties for both the competitor and the person who performs the event. Therefore, lariat ropes with characteristics that prevent and/or avoid injury or suffering to the animal are developed.

Research on background information, directed to ropes of Team Roping, 3 and 4-strand ropes were found, which able to be twisted or not. These ropes have some limitations in relation to their use, especially the rope of 3 strands, since the contact area in the animal body might lead to serious injuries due to their more prominent strands, resulting in lower elasticity. In the process of manufacturing and constructing a rope, there are crowns, which are protrusions resulting from the torsion process itself (in the case of twisted ropes). The traditional 3-strand ropes have larger and protruding crowns, thus, with their use in competitions it ends up degrading (shivering) faster. Therefore, it was noticed that larger and prominent crowns increase the injury in the animal body.

There is also the manufacture of 4-strand ropes, which can be twisted or not, these are more efficient in their use compared to 3-strand ropes, as 4-strand ropes have smaller crowns compared to 3-strand ropes that is, they have more elasticity and become softer. In turn, the coefficient of friction of a rope containing 6 strands is lower when compared to the usual 3 or 4-strand ropes. This friction reduces or brings to zero the number of injuries by the friction of the rope in the act of the roping.

Searches were carried out in the INPI (National Industrial Property Institute) database, regarding the state of the art, with the search for the competition ropes or loop, a process was found that bears similarity to the intended patent, which is the patent entitled Constructive Arrangement in Twisted Nylon Rope for Team Roping Competition. This patent was developed by the applicant applying for the procedure set forth herein, CONSTRUCTIVE ARRANGEMENTS IN 6-STRAND SYNTHETIC TWISTED LARIAT ROPE. In this way, we highlight some points of similarity with the patent sought, between the rope of 4 strands and the rope of 6 strands.

The patent to which we refer above has its priority dated May 18, 2015, whose process number is BR 20 2015 011399 0. It was an improvement over the four-strand rope, since the existing ropes had a deficiency due to the composition of simple polyester yarns without twisting. The improvement presented in this patent was the way that the simple yarn is given a twist in order to maintain consistency promoting greater, more elastic and dynamic durability when compared to a simple yarn that is static, which results in a greater durability, softness and elasticity, bringing benefits for both the animal and the competitor. In summary, we have the presentation of the rope of 4 strands using 12 cabled yarns, 2 nylon cabled yarns (5), twisted in the “S” direction, with 5600 decitex; 4 nylon cabled yarns (7), twisted in the “S” direction, with 8400 decitex; 6 nylon and polyester cabled yarns (6), twisted in the “S” direction, with 8100 decitex; twists per meter which can vary between XXS, XS, S, MS, M, HM, MH, H. The gauge can vary between 9.00 mm to 10.50 mm and the possibility of addition of a core (4), where the rope may contain from four to 6 nylon cabled yarns (7) in its inner part forming the core (4), and which may vary from 33,600 decitex to 50,400 decitex. The similarity that exists between the rope of 4 strands and 6 strands is the use of the cabled yarns twisted in the “S” direction, which is a technique already protected by the applicant, the number of cables, strands and decitex being different.

Searches were made in the international patent database, concerning the state of the art, with the search aimed at the competition or loop ropes, a process was found that bears similarity to the patent sought, which is the patent denominated “LARIAT, LARIAT ROPE BODY, METHOD AND APPARATUS, whose process number is U.S. Pat. No. 6,470,664, published on Oct. 29, 2002.

The aforementioned patent, by the number U.S. Pat. No. 6,470,664, discloses constructive arrangements in rope for animal roping. The summary of the patent is set out as follows: “A novel and superior lariat and lariat rope body for calf and steer roping having a core of monofilaments in the center around which three or more strands of twisted monofilament yarns are wound tightly to form the rope. A novel method of making lariat rope bodies and apparatus used are also disclosed. The rope body has a core in at least about 68 percent of the length of the rope body beginning with the honda end.”

The new design of the 6-strand lariat rope referred to in this patent is the result of several studies and observations, and the new rope structure has been conveniently designed to better adapt to Team Roping competitions, welfare of the animal and also the comfort of the competitor.

### Novelty and Objectives of the Invention

Thus, it is an object of the present invention to characterize the peculiar embodiment of CONSTRUCTIVE ARRANGEMENTS IN 6-STRAND SYNTHETIC TWISTED LARIAT ROPE. The novelty presented in the peculiarity of the exposed patent is the new formation and design of the 6 twisted, since no rope in this field of activity has 6 strands, in this way it is totally new and has in its characteristic the requirements of novelty, industrial application and distinctiveness.

The main objective of the patent is to search for animal welfare, the comfort of the competitor, having a rope that has smaller crowns, always seeking to provide a reduction of physical impact and pressure to the animal when it is pulled out of its trajectory with a smoother stop and a safer immobilization and with reduced animal stress. The basis for the construction of the rope is always focused on the animal welfare.

### DESCRIPTIONS OF THE DRAWINGS

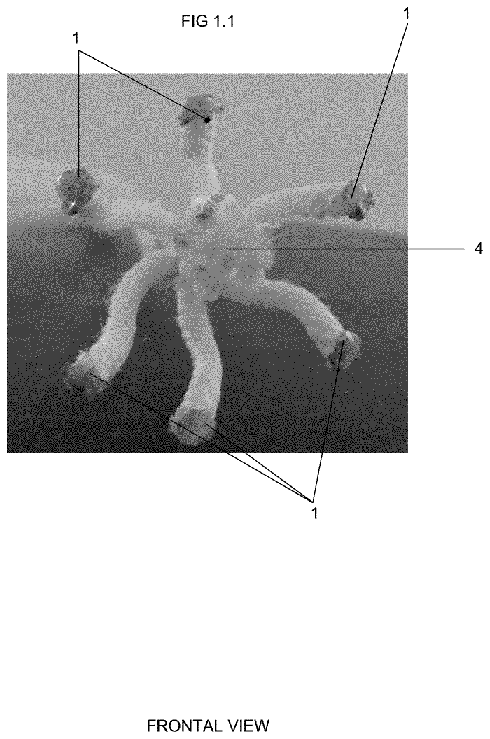

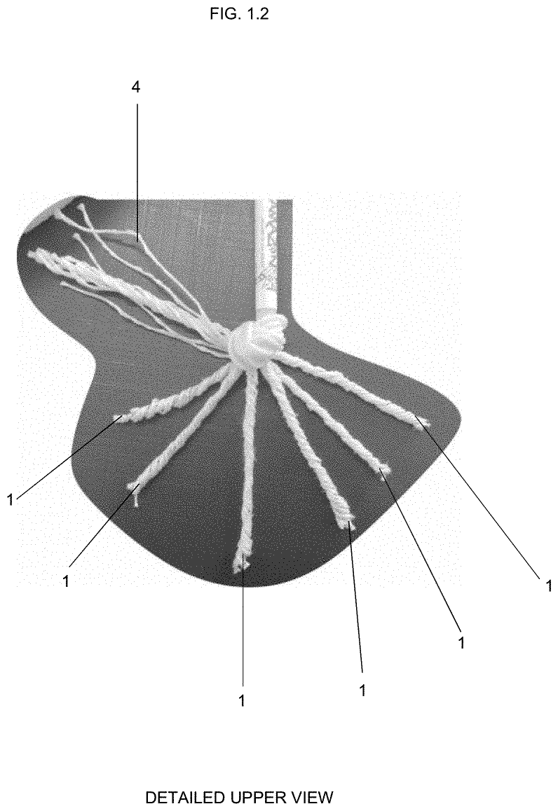

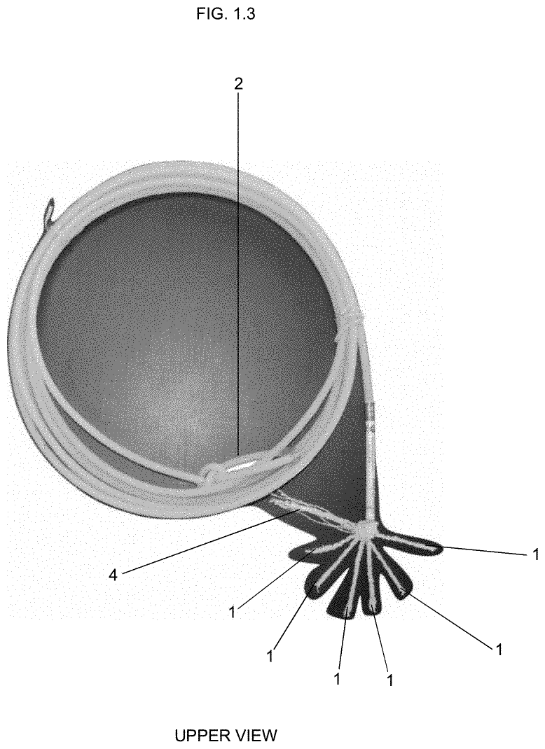

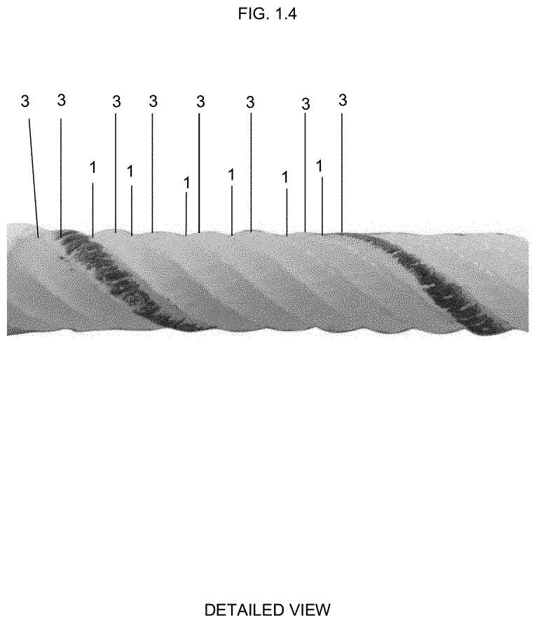

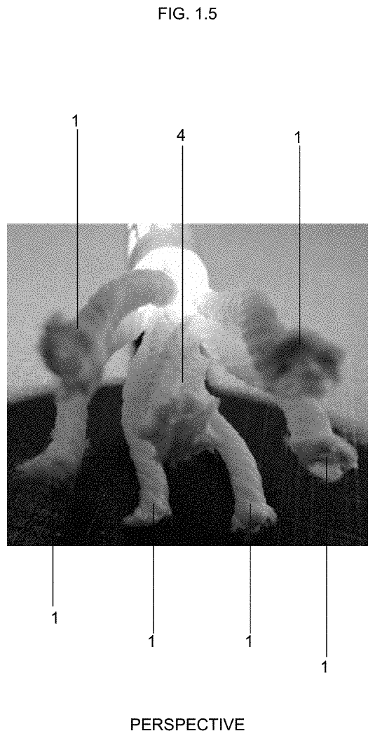

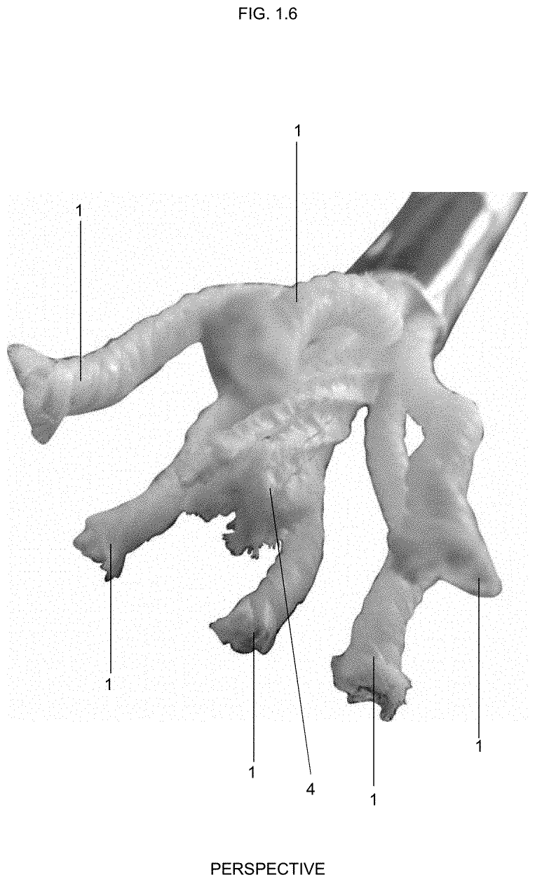

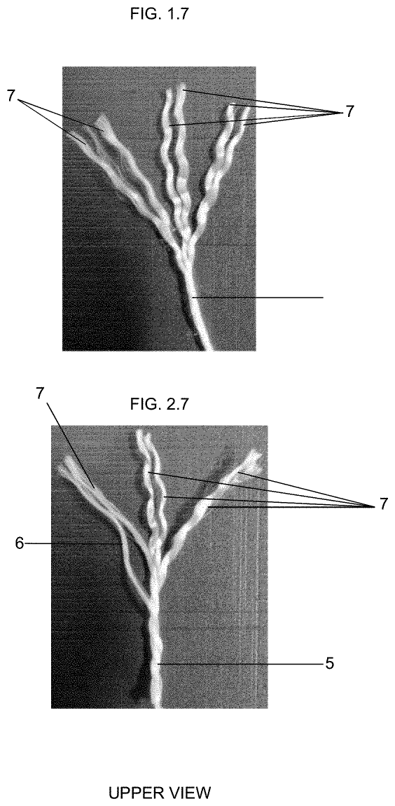

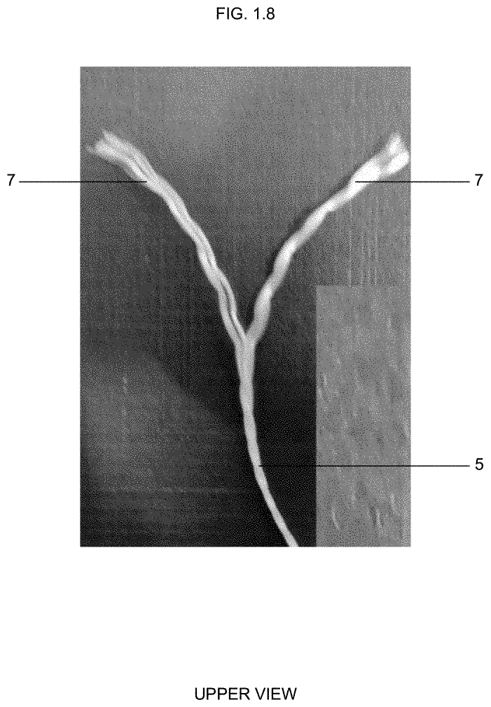

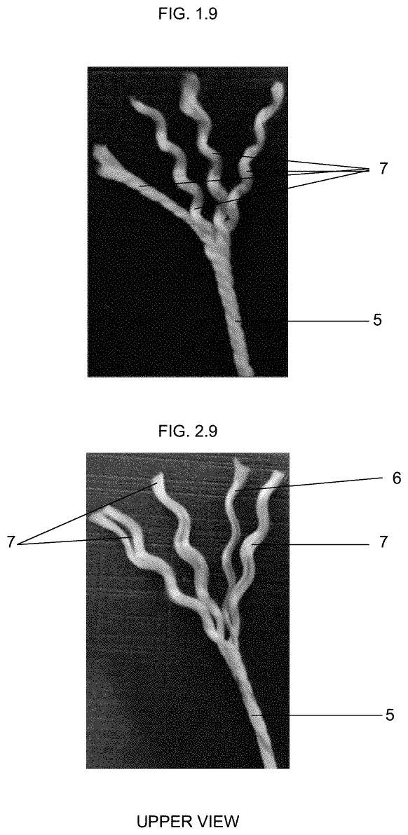

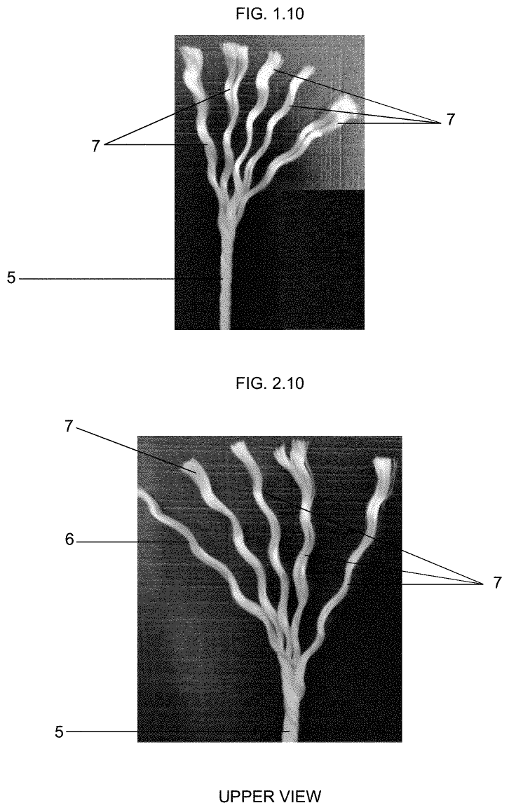

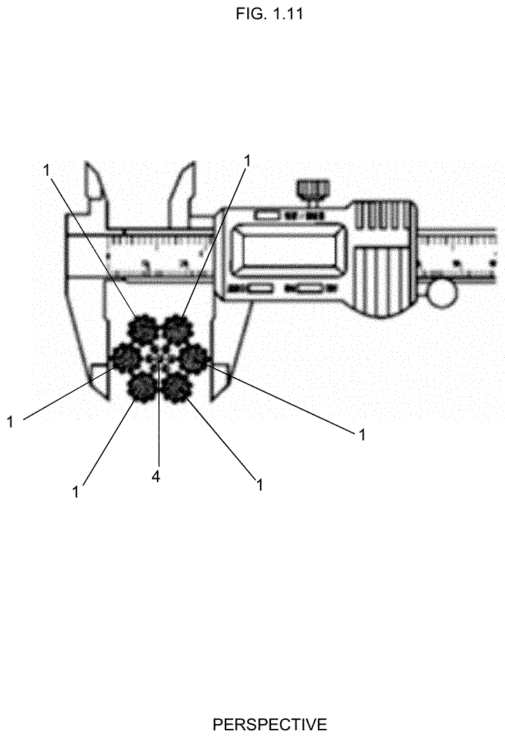

On page 1/11, FIG. 1.1 shows the strands (1), in this case 6 strands (1), and the core (4), in a frontal view, with the rope partially twisted.

On page 2/11, FIG. 1.2 shows, in a detailed superior view, the components of the 6-STRAND SYNTHETIC TWISTED LARIAT ROPE, which are not joined in its final formation, thus the 6 strands are shown (1), when twisted together make the strands (1) and the core (4).

On page 3/11, FIG. 1.3 shows the final rope, therefore, the honda (2), the 6 strands (1), and the core (4) are perceptible.

On page 4/11, FIG. 1.4 demonstrates in detail how the strands are set (1) forming the body of the rope, resulting in protusions called crowns (3). The crowns (3) are the protusions that the rope has when interlacing or twisting the strands (1).

On page 5/11, FIG. 1.5 shows, in a perspective view, the components forming the body of the rope: the strands (1) and core (4), which are twisted.

On page 6/11, FIG. 1.6, in a perspective view, shows the strands (1) and the core (4).

On page 7/11, FIGS. 1.7 e 2.7, in an upper view, are shown. FIG. 1.7 shows the cabled yarns, called N3 (5), that is twisted in “Z”, 100% polyamide. FIG. 2.7 shows the cabled yarns (5) called N3P, obtained from the torsion of 1 yarn A1 with 1 yarn P (6) in “Z”, resulting in an A2 yarn (7) mixed, after 2 sets of A2 yarns 100% polyamide are joined with 1 yarn A2 (7) mixed, resulting in 1 cabled yarn N3P in “S.

On page 8/11, FIG. 1.8, in an upper view, shows the cabled yarn, obtained from the resulting joint of 2 yarns (5) A2 (7) and twisted in “S” (5).

On page 9/11, FIGS. 1.9 and 2.9 are shown in an upper view. In FIG. 1.9, there is the composition of cabled yarn N4 (5), which is the resulting joint of 4 yarns A2 (7) twisted in “S”. FIG. 2.9 shows the cabled yarn N4P (5), which is the joint of a cabled yarn N4 (5) with a yarn P (6) (Yarn P:1100 decitex simple, not twisted).

On page 10/11 FIGS. 1.10 and 2.10 are shown. In FIG. 1.10, we have the composition of the cabled yarns called N5 (5), which results in the union of 5 yarns A2 (7) twisted in the “S” direction. In FIG. 2.10, the cabled yarn N5P (5) is exposed, which is the union of an N5 cabled yarn (5) with a P (6) yarn (Yarn P: 1100 decitex simple without twist).

On page 11/11, FIG. 1.11 shows a mere illustration and exemplification of how the diameter of a rope with strands is obtained.

### DETAILED DESCRIPTION OF THE INVENTION

The new construction of the 6-STRAND SYNTHETIC TWISTED LARIAT ROPE has smaller crowns (3) compared to those of 4 strands (1), and during the development of the loop the friction areas between the rope and the animal body will be dispersedly distributed. Therefore, dissipating impact and reducing friction generated by these crowns (3) of 6 strands (1), where this friction will be reduced or won't exist.

The aforementioned invention, 6-STRAND SYNTHETIC TWISTED LARIAT ROPE, i.e. 6 (six) strands (1) twisted along the rope body itself. This construction arrangement will distribute the tension load at the 6 strands (1) resulting in greater elasticity compared to the state of the art. This dynamic elastic effect of 6-strand rope provides reduction of the impact of the animal at traction moment, taking the steer out of its trajectory with a softer stop and a safer animal immobilization with reduced animal stress, as discussed above.

The present patent has a core in its construction (4). This is necessary because in its inner compartment there is a space due to the reduction of the caliber of the crowns (3), this space must be filled to support the outer crowns (3) to prevent internal collapse of the strands (1) when subjecting the rope to traction. This inner filling is made with any desirable synthetic fiber, which is accommodated in its interior giving a damping to the body of the rope.

The core (4) and the body of the 6-strands rope may vary from any titre or any desirable synthetic material such as polyamide (PA), polyester (PES), polypropylene (PP), elastane and aramid (Kevelar) in its composition. The patent 6-STRAND SYNTHETIC TWISTED LARIAT ROPE, uses the polyamide PA (nylon) 1400 decitex (1260 denier) synthetic fiber that makes the rope body itself, but they can vary from 940 decitex to 2100 decitex, preferably between 1160 decitex to 1880 decitex. For the manufacture of the core, 1400 decitex is used with the following construction: 1400 X 2 (Z) X 3 (S) X 14 (Z), resulting in 14 N3 cabled yarns (5). At the same time as the twisting of the rope body at “Z” occurs simultaneously the introduction of the core (4) in its interior. Therefore, using 7 to 21 cabled yarns N3 (5), preferably 11 to 17 cabled yarns N3 (5), even better 12 to 16 cabled yarns N3 (5). Arranged to accommodate twisting in the “Z” direction within the body of the rope by filling the empty space therein avoiding the collapse of the strands (1) of the rope. The total decitex of the core (4) may vary between 58800 to 176400 decitex, using between 92400 to 142800 decitex or between 100800 to 134400 decitex. In the patent 6-STRAND SYNTHETIC TWISTED LARIAT ROPE, it is used 117600 decitex as follows: 1400 x2x3x14 totaling 117600 decitex, i.e., in this measure of decitex it is observed that there is no extravasation of the core (4), much less the internal collapse of the strands (1). The range of the yarn construction and twisting options (5) may vary according to the titration adopted.

In Brazil, the yarn titration (5) in Decitex is used. In the United States (USA) the nomenclature used is Denier, with 1 Denier being equivalent to 1.1111 decitex and/or 1 decitex is equivalent to 0.9999 denier

In the construction of the cabled yarns (5) as mentioned above, various synthetic materials may be used. In the present invention Polyamide (PA-nylon) is used in up to 100% of its composition or may be blended with the addition of polyester percentages which may get to 50%, with the use of 25% polyester, preferably. In the 6-STRAND SYNTHETIC TWISTED LARIAT ROPE, the composition used is the addition of 84% polyamide and 16% polyester in the total composition.

The torsion system can be Z or S, these torsions refer to their directions, which can be to one side or another, identified by the letters “Z” which is the right torsion or “S” torsion to the left.

The method used and titration of the yarn A1 adopted for the development of 6-strand rope (1) can range from 940 decitex to 2100 decitex, preferably between 1160 decitex to 1880 decitex and more than 1400 decitex. The titre 1400 decitex is the option chosen, but substitutions cited above may occur for the construction, which is acceptable.

Therefore, the yarn can be constructed as below, in which A is a single yarn, N a resulting cabled yarn 100% polyamide (Nylon), the numerals 1, 2, 3, 4, 5 means the number of cabled yarns (5), that the strand has and P is the 100% polyester yarn.

YARN A1: 1400 decitex (1260 denier) simple, not twisted, 100% polyamide.

YARN A2: 2800 decitex twisted in “Z”, 100% polyamide.

YARN A2 MIXED: 50% polyamide+50% polyester twisted in “Z”.

CABLED YARN N1: the result of joining 2 yarns (5) A1 twisted in “S”.

CABLED YARN N2: the result of joining 2 yarns (5) A2 twisted in “S”.

CABLED YARN N3: the result of joining 3 yarns (5) A2 twisted in “S”.

CABLED YARN N4: the result of joining 4 yarns (5) A2 twisted in “S”.

CABLED YARN N5: the result of joining 5 yarns (5) A2 twisted in “S”

YARN P:1100 decitex simple, not twisted.

CABLED YARN N3P: 7000 decitex twisted in “S”.

In order to obtain the CABLED YARN N3P (5), the twist of 1 yarn A1 together with 1 Yarn P is made in “Z”, resulting in a blended yarn A2 (7), after joining 2 sets of A2 (7) 100% polyamide with 1 blended A2 (7) yarn, this results in 1 N3P cabled yarn in “S”. The N3P cabled yarn consists of 16.666% polyester and 83.333% polyamide. This composition can vary according to the desire to add bright or dull colors.

Each of the six strands (1) comprising the rope may be constituted, with only cabled yarns N1 (5), N2 (5), N3 (5), N4 (5) or N5 (5), or with the mixture between them in a way that cabled yarns N1 (5) can coexist with cabled yarns N5 (5) in multiples options and variations involving cabled yarns (5) N1, N2, N3, N4, N5, N2P, N3P, N4P, N5P, N2, N2, N2, N3P, N4P, N5P, standardized or mixed. It is desirable for the manufacturing, development and obtainment of artifacts which can be shaped for each of the 6 strands (1) which gives a friction or sliding effect to the rope body, thus meeting requirements of each competitor. In the case of this invention it is acceptable to use all these forms of construction, more preferably the N3 cabled yarns. The range of the cabled yarns construction options (5) for the composition of each of the 6 strands (1) in the aforementioned invention may comprise different desirable titrations and their variations cited above. Therefore, each of the strands (1) may contain titrations which may range from 201600 decitex to 403200 decitex, more preferably from 235200 decitex to 369600 decitex and more preferably from 268800 decitex to 302400 decitex.

After determining the total desired composition of the rope body construction, each of these 6 strands (1) will be twisted in the “S” direction and the joint of these 6 strands (1) in a single body will be twisted in the “Z” direction. Therefore, the body rope of the aforementioned invention has a Z-twist, and its core (4) also has a Z-twist. The gauge of the rope body with the core (4) of the invention may range from 08 millimeters to 12 millimeters, preferably from 8.5 millimeters to 11 millimeters and more preferably from 9 millimeters to 10.5 millimeters. In order to measure the correct diameter of the gauge of a rope it is necessary that the strands (1) are in a hexagon position, as shown in the figure on page 11, in FIG. 1.11, that the caliper is exposed.

With the constructive process of the 6-STRAND SYNTHETIC TWISTED LARIAT ROPE, a micro crystalline wax is passed in high temperatures and cooled rapidly. A 10 cm loop is made at the back end of the rope, which is called honda (2). Upon completion of this loop, a bovine leather is attached at its end to facilitate sliding of the rope body avoiding friction and facilitating the closure of the loop.

In relation to the twisting of the strand, they have variations, these twists determine the degree of softness or hardness of the string ranging from very soft to hard. In this variation, 7 (seven) types of twists are distinguished, which are distinguished by meter (TPM) and/or crowns (3) per meter, in a rope having from 385,800 decitex to 453,600 decitex total, with gauge varying between 09 millimeters to 10.5 millimeters.

Therefore, the twists can be of types:

XXS—Extra Extra Soft: having between 186 and 240 crowns (3) per meter.

XS—Extra Soft: having between 188 and 242 crowns (3) per meter.

S—Soft: having between 190 and 244 crowns (3) per meter.

MS—Medium Soft: having between 192 and 246 crowns (3) per meter.

M—Medium, having between 194 and 248 crowns (3) per meter.

HM—Hard Medium: having between 196 to 250 crowns (3) per meter.

MH—Medium Hard: having between 198 to 252 crowns (3) per meter.

In the 6-STRAND SYNTHETIC TWISTED LARIAT ROPE, it is observed that the factor determining the degree of torsion (degree of hardness) is related to the number of crowns (3) per meter in the body of the rope, that is, the greater the number of crowns (3) or twists around its own body, the harder the rope will be.

The body of the 6-strand rope (1), where the whole core (4) is not included; only the six strands (1) of the aforementioned invention may contain a range of construction variations ranging from 201600 decitex to 403200 decitex, and preferably from 235200 decitex to 369600 decitex, and more preferably for this patent from 268200 decitex to 302400 decitex. To this final value, the most appropriate total value of the core (4) of 117600 decitex is added. Therefore, in the case of the present invention, the rope body in its ready totality of 6 strands (1) with the core (4) may vary from 385,800 decitex to 4,200,000-decitex total.

Team Roping lariat ropes are very specific in their particularity, presenting variations of gauges (circumferences), twist variations (degree of hardness), variations in elasticity, variations in the percentage of addition of polymers. In the subscribed patent, there are additions of Polyamide (PA) and Polyester (PES) in the twist of the yarns; this determines the elasticity of the rope as well as its coloration. There are determinant climatic interferences in the act of the construction of the rope, therefore, the addition of more polyamide or more polyester will depend on the variation of temperature, humidity and the seasonality of solar luminosity. These factors are taken into account before the manufacturing of the rope, because a rope exposed to temperature, luminosity and humidity interference will present different performances, because these weather factors decisively influence the performance of a competition rope.

6-STRAND SYNTHETIC TWISTED LARIAT ROPE, is the result of a continuous development and study of a period of 36 months. Specific machines have been developed for its upgrading and creation, searching for improvements of a work and competition tool that can bring safety to those who handle it, as well as the welfare of the steer roped, bringing extraordinary performance in competitions that are determined by timers.

1- “CONSTRUCTIVE ARRANGEMENTS IN 6-STRAND SYNTHETIC TWISTED LARIAT ROPE” product used in team roping competition. It is characterized by 6 strands twisted in its construction or 6 unified strands.

2- “CONSTRUCTIVE ARRANGEMENTS IN 6-STRAND SYNTHETIC TWISTED LARIAT ROPE”, as claimed in 1, is characterized by being constructed with different synthetic materials such as polyamide (PA) or polyester (PES), in each of the six strands comprising the rope may be constituted, with only cabled yarns N1 N2, N3, N4 or N5, or with the mixture between them in a way that cabled yarns N1 can coexist with cabled yarns N5 in multiples options and variations involving cabled yarns N1, N2, N3, N4, N5, N2P, N3P, N4P, N5P, N2, N2, N2, N3P, N4P, N5P, standardized or mixed, having multiple twisted shapes, twisted with each other, presenting different shades, colors, resistance, diameters, elasticity and dynamic behavior. Therefore avoiding the climatic influence of humidity and temperature, enabling in its development the obtainment of artifacts which can be shaped for each of the 6 strands which gives a friction or sliding effect to the rope body. Its composition can be of 100% polyamide (PA) or polyamide with polyester.

3- “CONSTRUCTIVE ARRANGEMENTS IN 6-STRAND SYNTHETIC TWISTED LARIAT ROPE” as claimed in 2, is characterized by using a tritation of 1400 decitex, which can vary according to the necessity between 940 decitex to 2100 decitex or 1160 decitex to 1880 decitex, if other tritations are used in the construction of each of the 6 unified or twisted strands, resulting in a tritation of the body of the rope between 201600 decitex to 403200 decitex, or from 235200 decitex to 369600 decitex or even 268800 decitex to 302400 decitex.

4- “CONSTRUCTIVE ARRANGEMENTS IN 6-STRAND SYNTHETIC TWISTED LARIAT ROPE” as claimed in 1 is characterized by having twists per meter, which define the hardness and softness degree of the rope, ranging from XXS, XS, S, MS, M, HM, MH, H and a diameter which can vary from 9.00 mm to 10.50 mm.

5- “CONSTRUCTIVE ARRANGEMENTS IN 6-STRAND SYNTHETIC TWISTED LARIAT ROPE” as claimed in 1 is characterized by allowing the user choice the addition of the core, composed by a variation of cabled yarns ranging from N1 to N5, presenting 14 cabled yarns N3 totaling 117600 decitex in its construction, 1400 x2 x3 x14 totaling 117600. Other decitex tritations can also be used, ranging from 58800 to 176400 decitex, or 92400 to 142800 decitex or even 100800 decitex to 134400 decitex, any variation can be used.

6- “CONSTRUCTIVE ARRANGEMENTS IN 6-STRAND SYNTHETIC TWISTED LARIAT ROPE” as claimed in 1 is characterized by having a final presentation of preferably between 385800 to 453600 decitex total.
